(19) United States
(12) Patent Application Publication
(10) Pub. No.: US 2003/0083974 A1
(43) Pub. Date: May 1, 2003

(54) Method and system for managing display of quotes for securities from multiple sources

(76) Inventor: John Bunda, Austin, TX (US)

Correspondence Address: CONLEY, ROSE & TAYON, P.C., P.O. BOX 398, AUSTIN, TX, 78767-0398, US

(21) Appl. No.: 10/014,948

(22) Filed: Oct. 26, 2001

(51) Int. Cl. G06F 17/60

(52) U.S. Cl. 705/37

(57) ABSTRACT

A computer-implemented method and system for managing display of quotes for securities from multiple sources are disclosed. The computer system may display one or more quotes provided by a first source. The system may suppress display of one or more quotes from other sources where the suppressed quotes are duplicates of quotes from the first source which are displayed. The computer system may display and/or suppress quotes based on user preference data. If communications with the first source of quotes is interrupted, the system may display quotes from another source. If communications with the first source cease to be interrupted, the system may resume display of quotes from the first source and suppression of quotes from other sources where the suppressed quotes are duplicates of quotes from the first source which are displayed.

### BACKGROUND OF THE INVENTION

1. Field of the Invention

The present invention generally relates to computer software. Certain embodiments relate to computer-implemented methods for displaying securities quotes from multiple sources.

2. Description of the Related Art

The securities trading industry has burgeoned since the advent of the Internet. Many companies offer securities trading services through a variety of automated systems and methods, such as a telephone system or a computer system. A securities trading company may allow a trader to view information about securities using such automated systems and methods. Such information may aid a trader in making buy and/or sell decisions regarding one or more securities. A securities trading company may provide quotes for securities via a computerized securities trading system.

A securities market may use several market centers to match buyers and sellers of a security. For example, the NASDAQ Stock Market uses the Small Order Exchange System (“SOES”) and Electronic Communication Networks (“ECNs”). The SOES and ECNs may be referred to as market centers. Examples of ECNs may include Arcapelago (“ARCA”), Instinet (“INCA”), Island (“ISLD”), Spear, Leads, and Kellogg (“REDI”), Attain (“ATTN”), Brut (“BRUT”), Strike (“STRK”), and MarketXT (“MKXT”), Night Trade (“NTRD”), and SelectNet (“NASD”). Market centers may maintain an order book including a list of open orders and or quotes. A market center's order book may be communicated to a securities market electronically.

To facilitate trading, a securities market may provide traders with open quote, and order information. Open quote and order information may be provided in a plurality of ways. A first way may be that an overall market summary for a security may be provided. The overall market summary for a security may include a best bid and best ask price available on the market at the time of the summary regardless of the market center listing the bid or ask price. For example, the best bid price may be a limit order available to the market through an ECN, while the best ask price may be a quote from a market maker. A second way that quote and order information may be provided is through a market quote/order book. A market quote/order book may include the best bid and/or best ask price from each market center and/or each market maker participating in the trading of a security.

Market makers participating in a securities market commit capital to buy and sell securities on the market. Under the rules of certain markets, for example the NASDAQ Stock Market, a market maker participating in the trading of a particular security is expected to provide both buy and sell quotes for a security. These quotes do not necessarily represent actual orders, rather they represent a willingness on the part of the market maker to execute transactions at the quoted price.

A computerized securities trading system that provides quotes to traders may receive quotes for securities from multiple sources. For example, a market center may send quotes to the computerized securities trading system via a computer network (e.g., the Internet). In addition the market center may send quote information to the securities market. The securities market may process the quote information to generate a market quote/order book and/or a market summary. The market quote/order book and/or market summary may then be sent to the computerized securities trading system. A securities market quote may be considered an “indirect” source or feed for quotes. The computerized securities trading system may provide a trader with access to both market center quotes, and securities market quotes.

### SUMMARY OF THE INVENTION

The present invention provides various embodiments of a method and system for displaying quotes received from multiple sources.

In one embodiment, a computerized securities trading system that displays quotes for securities to a trader may receive quotes from two or more sources. In such an embodiment, one or more quotes for a security may be duplicated within a securities trading system because a copy of the duplicated quote is received from both the securities market and a market center. For example, the securities market may provide the computerized securities trading system with the best quote that the market received from a particular market center. The quote may be provided either in the form of a market summary or market quote/order book. Similarly, the market center may provide the same quote directly to the computerized securities trading system. Therefore, the computerized securities trading system may receive the same quote directly from a market center and indirectly from a securities market. Quotes from all sources may be displayed on the same quote display window on a computer system. If both of the duplicated quotes are displayed to a trader, the trader may mistakenly believe that the two displayed quotes are distinct. In certain embodiments, the securities trading system may display only one instance of the duplicated quote.

In some embodiments, the determination of which instance of a duplicate quote to display may be user configurable. For example, a user may configure user preference settings identifying one or more sources of securities quotes from which to suppress duplicated quotes. In the event that a first source of quotes which is not suppressed becomes unavailable, the securities trading system may automatically display one or more quotes from an alternate source (i.e., a source other than the first source). If the first source becomes available again, the system may automatically display quotes from the first source again, and simultaneously suppress quotes from the alternate source.

The sources of quotes may include market centers and securities markets. Quotes from the market centers and securities markets may be displayed simultaneously on a user interface, such as a window on a computer screen. Some of the quotes provided by a securities market and a market center may be duplicated. Such duplicated quotes may be eliminated from a quote display window by suppressing the display of the duplicated quotes received from one of the sources of quotes by employing an embodiment of a method and system disclosed herein.

An additional embodiment may relate to a system configured to display quotes. The system may include a computer system coupled to a network. The computer system may include a memory configured to receive user configuration data from a user interface. The computer system may also include a display system configured to display quotes in a quote display format. The user configuration data may affect the quote display format. In addition, the computer system may be configured to receive quotes from the network and to display quotes in the quote display format.

A further embodiment may relate to a carrier medium which may store program instructions. For example, the carrier medium may include a memory medium. The program instructions may be computer-executable to implement a method for displaying quotes for securities. The method may include receiving quotes for a security from two or more sources such that one or more of the quotes are duplicated. The method may also include displaying one or more quotes provided by a first source. The method may further include suppressing the display of one or more quotes provided by a source other than the first source where the one or more quotes not displayed are duplicates of quotes from the first source which are displayed. The method may also include receiving user preference data that identifies sources of quotes. The identified sources of quotes may be sources whose duplicated quotes are to be suppressed. Alternately, the identified sources of quotes may be sources whose duplicated quotes are to be displayed. The method may further include displaying one or more quotes from one or more sources designated based on the user preference data. The method may further include suppressing the display of one or more quote from one or more sources designated based on the user preference data.

### BRIEF DESCRIPTION OF THE DRAWINGS

FIG. 1 depicts a network diagram of a wide area network which is suitable for implementing various embodiments;

FIG. 2 depicts an illustration of a typical computer system which is suitable for implementing various embodiments;

FIG. 3 depicts an exemplary embodiment of a computer-implemented method of communicating quote information from one or more market centers to a trader;

FIG. 4 depicts a flow chart of an exemplary embodiment of a computer-implemented method of displaying quotes from multiple sources;

FIG. 5 depicts a method of generating a quote display with quotes from a plurality of sources;

FIGS. 6a, 6b, and 6c depict alternate views of the quote display of FIG.5;

FIG. 7 depicts an embodiment of a quote display including bid quotes, ask quotes, and other information; and

FIG. 8 depicts an exemplary embodiment of a user preference selection screen.

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

A method and system for computerized trading of securities is illustrated in pending U.S. patent application Ser. No. 09/460,045, which is incorporated by reference as if fully set forth herein.

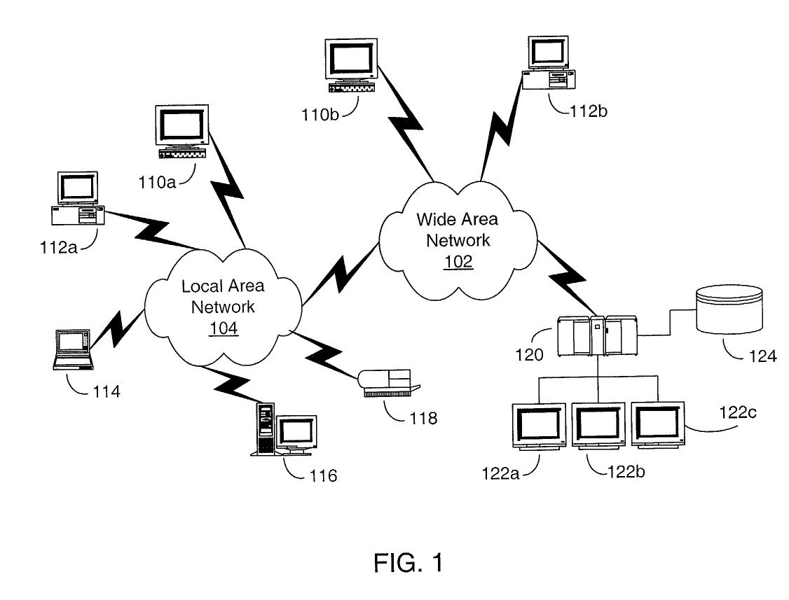

FIG. 1 illustrates a wide area network (WAN) according to one embodiment. WAN 102 is a network that spans a relatively large geographical area. The Internet is an example of WAN 102. WAN 102 typically includes a plurality of computer systems which are interconnected through one or more networks. Although one particular configuration is shown in FIG. 1, WAN 102 may include a variety of heterogeneous computer systems and networks which are interconnected in a variety of ways and which run a variety of software applications.

One or more local area networks (LANs) 104 may be coupled to WAN 102. A LAN 104 is a network that spans a relatively small area. Typically, a LAN 104 is confined to a single building or group of buildings. Each node (i.e., individual computer system or device) on a LAN 104 preferably has its own CPU with which it executes programs, and each node may also be able to access data and devices anywhere on the LAN 104. LAN 104 thus allows many users to share devices (e.g., printers) as well as data stored on file servers. LAN 104 may be characterized by any of a variety of types of topology (i.e., the geometric arrangement of devices on the network), of protocols, and of media (e.g., twisted-pair wire, coaxial cables, fiber optic cables, radio waves).

Each LAN 104 includes a plurality of interconnected computer systems and optionally one or more other devices, for example: one or more workstations 110a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. The mainframe terminals 122a, 122b, and 122c may access data stored in the storage device or file server 124 coupled to or included in the mainframe computer system 120.

WAN 102 may also include computer systems which are connected to WAN 102 individually and not through a LAN, as illustrated, for purposes of example: a workstation 110b and a personal computer 112b. For example, WAN 102 may include computer systems which are geographically remote and connected to each other through the Internet.

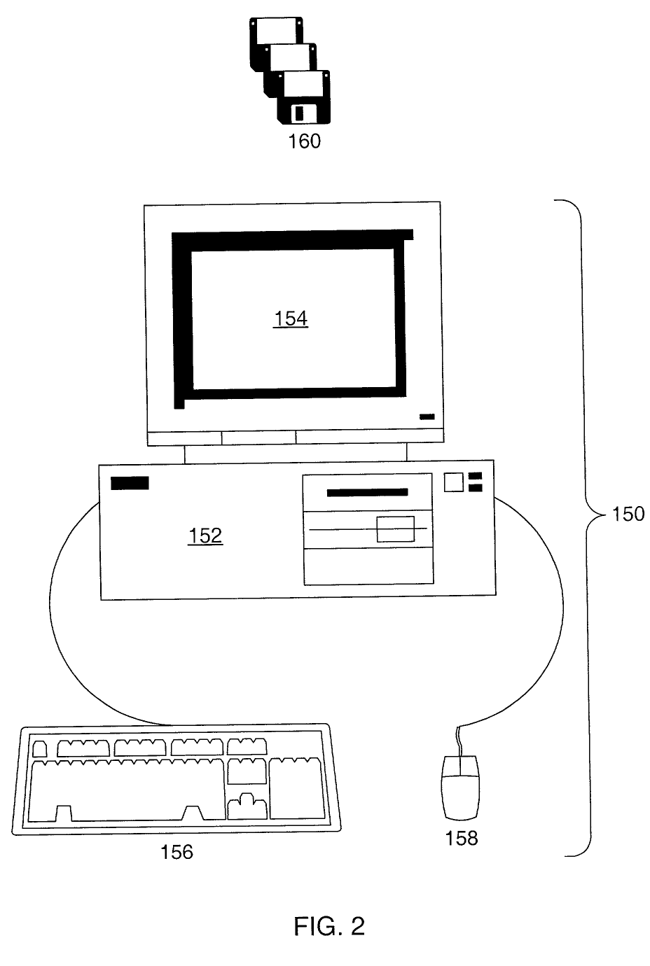

FIG. 2 illustrates a typical computer system 150 which is suitable for implementing various embodiments of a system and method for displaying securities quotes from multiple sources. Each computer system 150 typically includes components such as a CPU 152 with an associated memory medium such as floppy disks 160. The memory medium may store program instructions for computer programs, wherein the program instructions are executable by the CPU 152. The computer system 150 may further include a display device such as a monitor 154, an alphanumeric input device such as a keyboard 156, and a directional input device such as a mouse 158. Computer system 150 may be operable to execute the computer programs to implement a method of displaying securities quotes from multiple sources as described herein.

The computer system 150 preferably includes a memory medium on which computer programs according to various embodiments may be stored. As used herein, the term “memory medium” is intended to include an installation medium, e.g., a CD-ROM, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer may provide the program instructions to the first computer for execution. Also, computer system 150 may take various forms, including a personal computer system, mainframe computer system, workstation, network appliance, Internet appliance, personal digital assistant (PDA), television system or other device. In general, the term “computer system” as used herein is broadly defined to encompass any device having a processor which executes instructions from a memory medium.

The memory medium preferably stores a software program or programs for displaying securities quotes as described herein. The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), browser-based applications (e.g., Java applets), traditional programs, or other technologies or methodologies, as desired. A CPU, such as host CPU 152, executing instructions from the memory medium may include a means for creating and executing the software program or programs according to the methods described below.

As used herein, a “security” refers to an investment instrument, issued by a corporation, government, or other organization which constitutes evidence of debt or equity (e.g., stocks, options contracts, futures, bonds, mutual funds, and other investments).

As used herein, a “quote” refers to a willingness to buy or sell a specified number of shares of a security at a specified price. A “quote price” refers to the price specified in a quote. A solicitation to buy a security specifies a bid price. As used herein, a “bid price” refers to the price a buyer is willing to pay for a given security at a given time. Conversely, a solicitation to sell specifies an ask price. As used herein, an “ask price” refers to the price that a seller is willing to accept in exchange for the given security at a given time. As used herein, a “trade price” or “price” of a security may generally refer to a price of a transaction for the security. As used herein, a “trading direction” refers to whether the quote is an willingness to buy the security or an advertised willingness to sell the security. When the trading direction is an willingness to buy, the price may be referred to as a “bid price,” and the quote is referred to as a “bid quote.” Conversely, when the trading direction is a willingness to sell, the price may be referred to as an “ask price,” and the quote is referred to as an “ask quote.”

As used herein, a “market maker” may generally refer to an entity (e.g., a brokerage, a bank) that maintains an orderly market in a security by standing ready, willing, and able to buy and sell the security. As used herein, a “securities exchange” or “securities market” may generally refer to any organization, association, or group, which provides or maintains a marketplace where securities may be traded. Examples of securities markets include the New York Stock Exchange (NYSE), the American Stock Exchange (AMEX), and the National Association of Securities Dealers Automated Quotation (NASDAQ) system. As used herein, a “market center” may refer to a network or system which facilitates trading in securities. For example, an ECN may be considered a market center. An ECN may bring buyers and sellers together for the electronic execution of trades. As used herein, a quote sent from the market center to a computerized securities trading system may generally be referred to as a “market center quote.” As used herein, quote information sent from a securities market to the computerized securities trading system may be generally referred to as a “securities market quote.”

As used herein, an “order” refers to a request to buy or sell a specified number of shares of a security. An order which specifies a price is called a “limit order.” An order which does not specify a price is called a “market order.” A market order may be executed at the best price currently available on the market. As used herein, an “order book” may generally refer to a listing of open orders available through a market center.

As used herein, a “server” may generally refer to a computer program that, when executed, provides services to other computer programs executing in the same or other computer systems. The computer system on which a server program is executing may also be referred to as a server, though it may contain a number of server and client programs. In the client/server model, a server is a program that awaits and fulfills requests from client programs in the same or other computer systems. As used herein, a “client” may generally refer to a computer system or process that requests a service of another computer system or process.

As used herein, “automatically” may generally refer to an action taken without requiring manual steps on the part of the user.

As used herein, a “market quote/order book” may generally refer to a summary of the best available quote price from each market center participating in trading the particular security. Typically, the market quote/order book includes a bid quote and an ask quote for each market maker participating in trading the security. Typically, the market quote/order book also includes one or more open orders listed through each market center participating in trading the security.

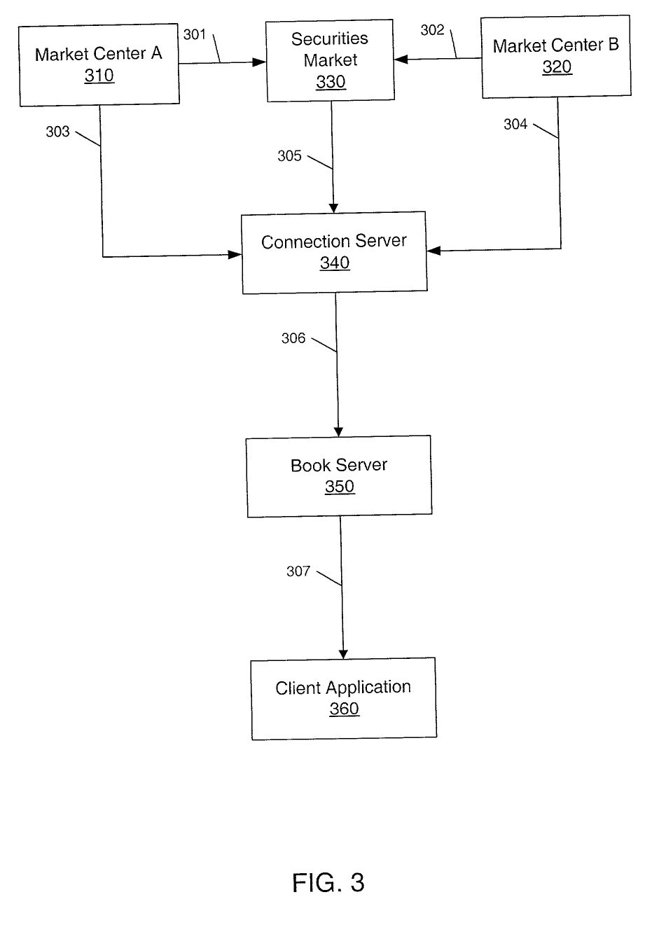

FIG. 3 depicts an exemplary embodiment of a method of communicating quote information from one or more market centers to a trader. In FIG. 3, each box (i.e., 310, 320, 330, 340, 350, and 360) represents a computer system and each arrow (i.e., 301, 302, 303, 304, 305, 306, and 307) represents a connection. A connection may be a connection through a LAN or WAN (e.g., the Internet). In some embodiments, a connection may be internal to a computer system. In such an embodiment, the connection may represent a data flow from one software application within a computer system to another software application within the computer system. In these embodiments, two or more of boxes 310, 320, 330, 340, 350, and 360 may reside within the same computer system. A connection through a LAN or WAN may include other hardware and/or software components which are not depicted in FIG. 3. For example, a connection through the Internet may include one or more routers or proxy servers. The embodiment depicted in FIG. 3 illustrates only two market centers and one securities market. Some embodiments may include more or fewer market centers and/or more securities markets.

Quote information may be generated at Market Center A 310, Market Center B 320 and securities market 330. Quote information generated at Market Center A 310 may then be communicated to securities market 330 and to connection server 340 as illustrated by data flow arrows 301 and 303, respectively. Likewise, quote information generated at Market Center B 320 may be communicated to securities market 330, and to connection server 340 as illustrated by data flow arrows 302 and 304, respectively. Quote information communicated to securities market 330 may be processed to generate a market summary and/or market quote/order book. The quote information may then be communicated to connection server 340 as illustrated by data flow arrow 305. Quote information may include, but is not limited to: a market center identification, a quote price, a trading direction, and a quantity (or size). In the embodiment depicted in FIG. 3, Market Center A 310, Market Center B 320, and securities market 330 may be considered “sources of securities quotes.”

The quote information may be communicated from each source of securities quotes in a known communications protocol. As used herein, a “communications protocol” may generally refer to a set of standardized rules for the format and exchange of messages. The communications protocol for each source of securities quotes may be different. A server application, called a connection server 340, may maintain a communications link to each source of securities quotes. Connection server 340 may convert the quote information received from each source of securities quotes into a single communications protocol. Additionally, connection server 340 may maintain a list of the market centers and securities markets that it may establish connections to, and the current status of each of these connections.

As shown in FIG. 3, connection server 340 may communicate with a book server 350 as illustrated by data flow arrow 306. Book server 350 may use the quote information to maintain a consolidated list of quotes for securities. Book server 350 may communicate with a client application 360 as illustrated by data flow arrow 307. Either book server 350 or client application 360 may store user preference settings. The user preference settings may include, but are not limited to an indication of one or more sources of securities quotes from which the display of duplicated quotes should be suppressed. For ease of reference, a source of securities quotes from which the display of duplicated quotes is suppressed may be referred to as a “suppressed source.” Among other things, book server 350 may communicate some or all of the consolidated list of quotes for securities to client application 360. Client application 360 may generate a quote display and/or receive input from the trader through a user interface. The quote display may display quotes to a user in a quote display format.

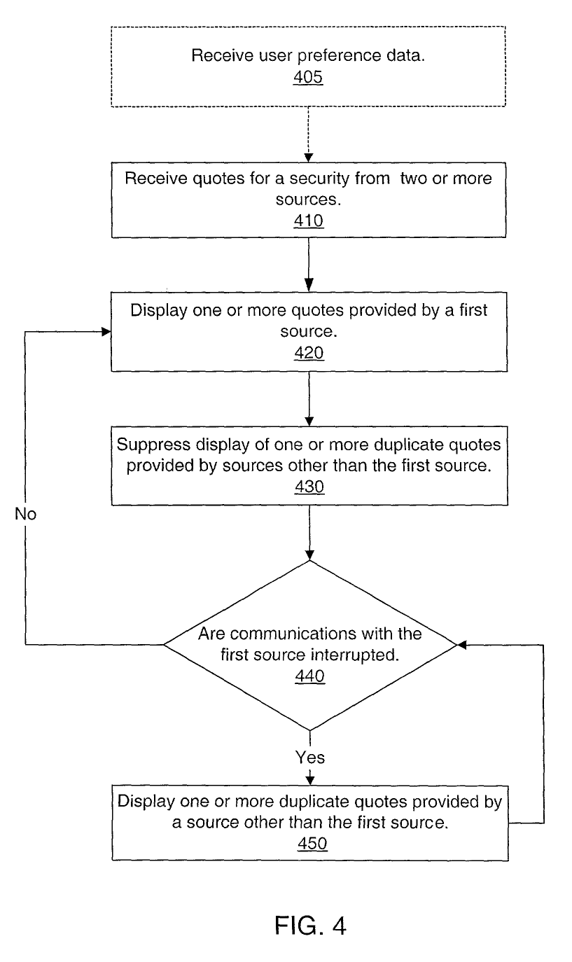

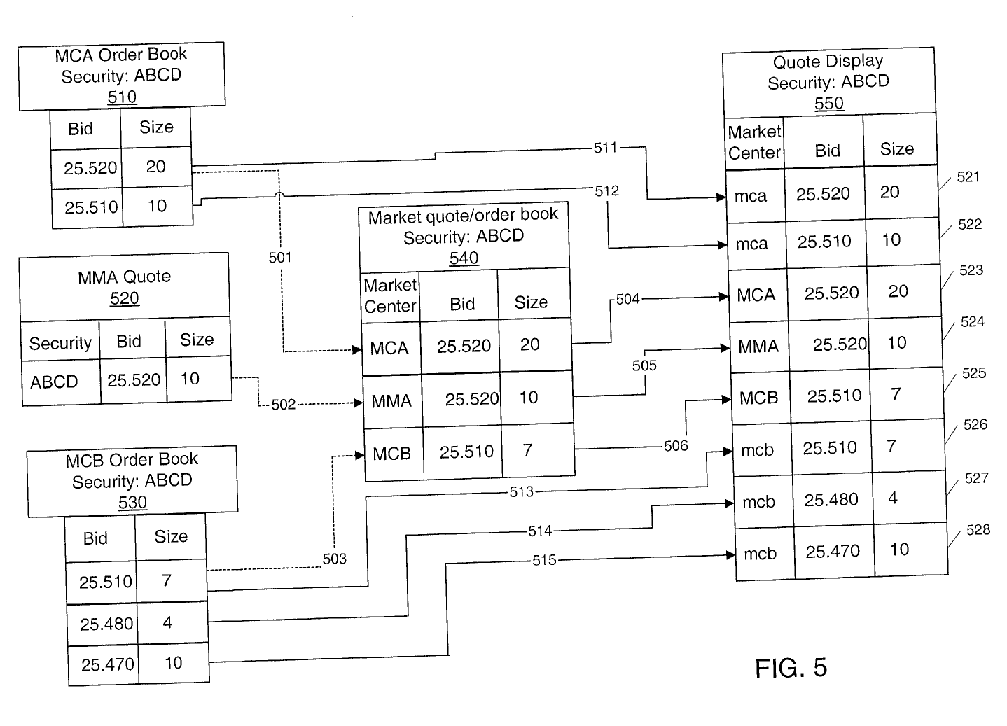

An embodiment of a method of displaying quotes from multiple sources on a computer system is illustrated in FIG. 4. In an embodiment, a computer system that displays quotes for securities may receive quotes from two or more sources 410. For reasons described below with regard to FIG. 5, one or more of the quotes may be duplicated when the same quote is provided by two or more of the sources. Displaying duplicated quotes may lead to confusion; therefore, it may be advantageous to eliminate duplication in the display of quotes from the multiple sources. The method may include displaying one or more quotes provided by a first source 420. Simultaneously, the method may include suppressing the display of one or more duplicated quotes provided by sources other than the first source 430.

In some cases, a connection to a source of quotes may be interrupted. Communication with a source or quotes may be interrupted for reasons such as, but not limited to, a loss of a network connection. In one embodiment, the method may include detecting an interruption of communications with one or more sources of quotes 440. If communications with the first source of quotes is interrupted, the system may display one or more of the duplicated quotes provided by a source other than the first source 450.

In an embodiment, the method may include determining if communications with the first source are no longer interrupted 440. If communications with the first source are no longer interrupted, the method may include displaying quotes from the first source 420 again. The method may also include simultaneously suppressing the display of duplicate quotes from sources other than the first source 430 again.

Optionally, the method may include receiving user preference settings (step 405). Step 405 is shown in dashed lines to indicate that the step is optional and may not be present in all embodiments. User preference settings may include a setting specifying which source of quotes should be suppressed.

An example of how the method depicted in FIG. 4 may be implemented is provided by reference to FIG. 3. Connection server 340 may provide messages to book server 350 indicating the status of connections between connection server 340 and each source of securities quotes. Thus, connection server 340 may inform book server 350 if one or more connections are interrupted. If a connection has been interrupted and is subsequently re-established, connection server 340 may inform book server 350 that the connection is no longer interrupted. If book server 350 receives a message indicating a change in the status of a connection (i.e., the connection is interrupted, or no longer interrupted), book server 350 or client application 360 may determine an appropriate action based on the user preference settings.

If the status of a connection to a suppressed source has changed, the appropriate action may be to notify a trader of the connection status change. Alternately, no action may be taken. If the status of a connection to a source that was not suppressed has changed and the status change was an interruption in the connection to the nonsuppressed source, the appropriate action may be to display the quotes from a source selected to be suppressed. If the status of a connection to a source that was not suppressed has changed and the status change was that the connection is no longer interrupted, the appropriate action may be to suppress the display of quotes from the source selected to be suppressed, and display the quotes from the non-suppressed source. For example, a user may select settings indicating that quotes from each market center 310 and 320 should be displayed, while duplicate quotes from securities market 330 should be suppressed. In such a case, if a connection to Market Center A 310 is interrupted (i.e., no communication takes place over data flow arrow 303) connection server 340 may detect the interruption. Upon detecting the interruption, connection server 340 may send a message to book server 350 indicating that the status of the connection to Market Center A 310 has changed to interrupted. Book server 350 may determine, based on the user preference settings, that quotes from Market Center A 310 are selected to be displayed to the trader, and duplicate quotes from securities market 330 are selected to be suppressed. Book server 350 may then display the quotes from securities market 330 which would have been duplicated if quotes were available from Market Center A 310.

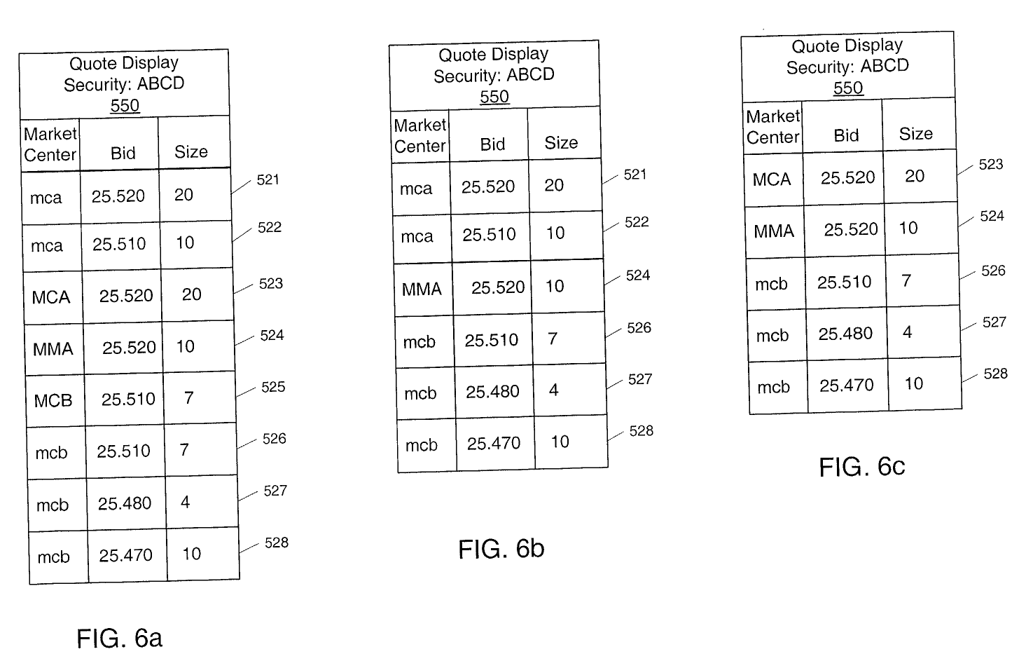

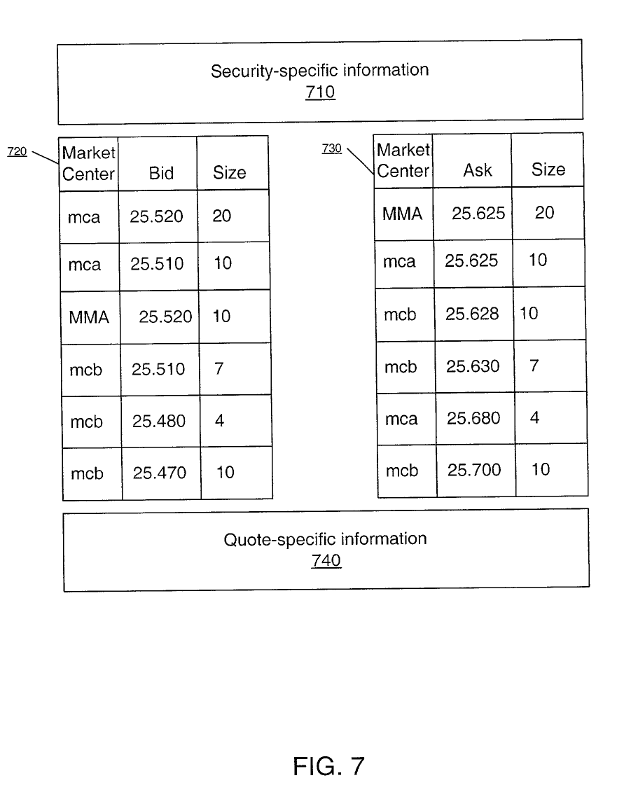

FIG. 5 depicts an exemplary embodiment of a method of generating a quote display. Continuing with the example set forth with regard to FIG. 3, the example depicted in FIG. 5 shows how quote information may flow from Market Center A 310, Market Center B 320, and securities market 330 to book server 350 of FIG. 3. Market center A (“MCA”) order book 510 may include quote information generated at Market Center A 310. Market center B (“MCB”) order book 530 may include quote information generated at Market Center B 320. Market maker A (“MMA”) quote 520 may represent quote information generated at securities market 330. The best quote or order from each of order books 510 and 530, and market maker quote 520 may be combined into market quote/order book 510 as represented by arrows 501, 502, and 503. Quote information communicated from securities market 330 to book server 350 through data flow arrows 305 and 306, as depicted in FIG. 3, may include a market quote/order book. Quote information in market quote/order book 540 may be used to create quote display 550 as represented by arrows 504, 505, and 506. Quote display 550 may also include quote information communicated directly from each market center (i.e., Market Center A order book 510, and Market Center B order book 530) as depicted by arrows 511, 512, 513, 514, and 515. It is noted that several quotes are duplicated in quote display 550. For example, quotes 521 and 523 are duplicates, and quotes 525 and 526 are duplicates. Duplicated quotes may appear two or more times in a quote display. However, the duplicated quotes may represent only a single quote from a market center. In an embodiment, quote display 550 may typically be sorted by price. However, to simplify depicting the flow of information illustrated in FIG. 5, embodiments of quote display 550, as depicted in FIGS. 5, 6a, 6b, 6c, are shown unsorted. Similarly, bid quotes 720 and ask quotes 730 depicted in FIG. 7 are also depicted as unsorted.

In an embodiment, a method of displaying securities quotes to a user may include setting or selecting a quote display format for a quote based on the source of the quote. For example, in FIG. 5, quotes incorporated into quote display 550 directly from market center order books 510 and 530 (i.e., quotes 521, 522, 526, 527, and 528) display the market center name in lower case letters. Quotes incorporated into quote display 550 from market quote/order books 540 (i.e., quotes 523, 524, and 525) display the market center name in upper case letters.

As depicted in FIGS. 6a, 6b, and 6c, the method may suppress the display of one or more duplicated quotes. For example, FIG. 6a depicts a quote display with no suppression of duplicated quotes. A user may select user preferences which indicate to the system that quotes from market quote/order book 540 which duplicate quotes from market center order books 510 or 530 should be suppressed. In such a case, the display of duplicated quotes from market quote/order book 540 may be suppressed as depicted in FIG. 6b. In the exemplary embodiment depicted in FIG.6b, quotes 523 and 525 from FIG. 6a have been omitted (i.e., suppressed). Quotes 523 and 525 were suppressed from being displayed because their source was market quote/order book 540 and they duplicated quotes 521 and 526, respectively. Since the sources of quotes 521 and 526 were market center order books 510 and 530, these quotes are displayed. Quote 524 is displayed because, although its source was market quote/order book 540, it does not duplicate a quote from any market center order book.

FIG. 6c depicts an exemplary embodiment of a quote display after a connection to a market center is interrupted. In the embodiment depicted in FIG. 6c, the connection to Market Center A has been interrupted. With the connection to Market Center A interrupted, data flows 511 and 512 from FIG. 5 no longer take place. Thus, quotes 521 and 522 are no longer displayed. The method may detect the interruption of the connection to Market Center A and modify the display of quotes. In particular, the method may display quote 523, as depicted in FIG. 6c.

FIGS. 5, 6a, 6b, and 6c depict only bid quotes. In an embodiment, a user interface may display a quote screen having both bid quotes and ask quotes. FIG. 7 depicts an embodiment of a quote screen having bid quotes 720 and ask quotes 730 for a security. The illustration in FIG. 7 may represent a screenshot of a user interface in which a series of bid quotes 720 for a security are displayed on one side (e.g., the left side) of the screenshot, and a series of ask quotes 730 for the security are displayed on another side (e.g., the right side) of the screenshot. In one embodiment, positioning of bid quotes 720 and/or the ask quotes 730 on the screenshot (e.g., left, right, top, bottom) may be user-configurable.

In an embodiment, security-specific information 710 may be displayed at the top of the screenshot. The display of security-specific information 710 in FIG. 7 is shown as expanding across bid quotes 720 and ask quotes 730. In one embodiment, positioning of security-specific information 710 on the screenshot (e.g., top, bottom, expanded, collapsed) may be user-configurable. Security specific information 710 may include, but is not limited to: a security symbol, a tick direction, a company name that corresponds to the security symbol, a type of business (e.g., Communications Equipment, Conglomerates), a previous closing price, a last printed trade price, a net change in price from the previous day's closing price, a highest trade price since opening of the trading session, a highest ask price since opening of the trading session, a last size (i.e., an actual number or a multiple of shares) traded, a current volume being traded, a lowest trade price since opening of the trading session, a lowest bid price since opening of the trading session, “bid×size” (i.e., the largest size bid at the inside quote), “ask×size” (i.e., the largest size ask at the inside quote), gap in price from previous day's closing price to today's opening price, and opening price of the trading session. The “×” in the two terms “bid×size” and “ask×size” represents multiplication (i.e., times). For example, a “bid×size” may be “90×1.” Similarly, an “ask×size” may be “95×1.”

As used herein, a “security symbol” may generally refer to a series of letters used to identify a security. As used herein, a “tick” may generally refer to the smallest change which may occur in a security's price. As used herein, a “tick direction” may generally refer to a direction (e.g., up or down) of change in a security's price as compared to the most recent trade price of the security. As used herein, an “inside quote” may generally refer to a difference between the best bid price and the best ask price quoted by any market center for a security.

As shown in FIG. 7, quotes may be displayed as columns of information related to bid quotes 720, and ask quotes 730. As depicted in FIG. 7, the columns of information displayed may include: market center identification, price, and size. Additional columns which may be displayed include, but are not limited to: a tick direction, a tick change, a quote date and time, and a quote condition. In some embodiments, the selection of columns to be displayed may be user configurable.

As shown, quote-specific information 740 may be displayed at the bottom of the screenshot. In one embodiment, positioning of quote-specific information 740 on the screenshot (e.g., top, bottom, expanded, collapsed) may be user-configurable.

Quote-specific information 740 may include, but is not limited to: a price, a number of shares, a market center identification, a market center identification number, a trailing stop price, a stop loss price, a selection mechanism (e.g., a “purchase” push-button), and an account identification number. Additional (or less) quote-specific information may be displayed based on user configuration settings. As used herein, a “trailing stop order” may generally refer to a stop loss order that may follow a favorable price trend. As used herein, a “trailing stop price” may generally refer to a price specified in a trailing stop order. As used herein, a “stop loss order” may generally refer to an order to buy or sell a quantity of a security if a specified price is reached or passed. For example, the specified price may be below the current market price, and the order may be to sell. As used herein, a “stop loss price” may generally refer to a price specified in a stop loss order.

Quote-specific information 740 may be displayed upon selection of a particular row from either bid prices 720 or ask prices 730 by a user. Fields in quote-specific information 740 may also be pre-filled with values taken from the selected row in either bid prices 720 or ask prices 730. A user may modify fields in quote-specific information 740. When the user determines that the fields in quote-specific information 740 represent an order that the user desires to place, the user may place the order by selecting a selection mechanism (e.g., selecting the “purchase” push-button).

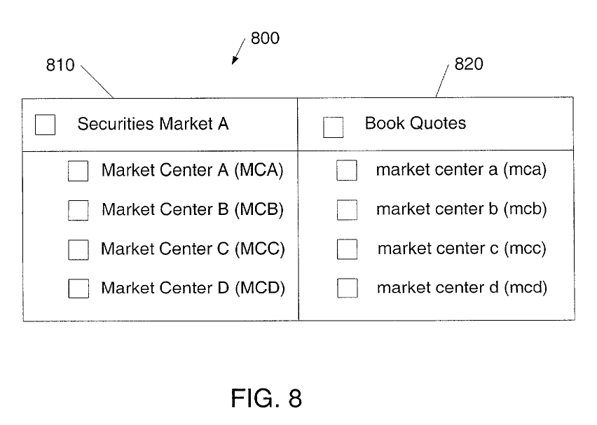

In an embodiment, a user may be provided with a user preference selection screen. The user preference selection screen may allow a user to select one or more sources of securities quotes to suppress as described above. An exemplary embodiment of a user preference selection screen is depicted in FIG. 8, and generally referenced by numeral 800. User preference selection screen 800 may be divided into columns. A first column (column 810) may relate to securities market selections. Column 810 may include a listing of each market center from which quotes may be received. As described with regard to FIG. 5, abbreviations of market center names in securities market column 810 may be displayed in all upper case letters. By selecting a checkbox associated with a particular market center, the user may indicate that quotes from that market center are to be suppressed according to embodiments described herein. For example, by selecting the checkbox associated with the listing for “Market Center A (MCA),” duplicated quotes from Market Center A coming from Securities Market A may be suppressed. Columns in screen 800 may also include a column header or title with an associated checkbox. By selecting the checkbox associated with the column title the user may indicate that quotes from all of the sources listed in that column should be suppressed. A second column (column 820) may relate to market center quotes. Market center quotes column 820 may function like column 810 except that selecting a checkbox associated with a market center name in column 820 may indicate that duplicated quotes received directly from that market center are to be suppressed. In some embodiments, a user may not be permitted to suppress both market center quotes and securities market quotes from a market center.

In some embodiments, quotes from more than one securities market may be available to the user. In such embodiments, screen 800 may include a column, or set of selections for each securities market. Screen 800 may also be incorporated as part of a larger user preference selection screen. Such a user preference selection screen may include, but is not limited to selections for the quote display format, a quote display sort order, and order default preferences. In alternate embodiments, a user preference selection screen may include other selection mechanisms such as are known. For example, the user preference selection may be indicated by moving the names of one or more source of quotes from a list of available quote sources, into a list of quote sources to be suppressed.

Various embodiments further include receiving or storing instructions and/or data implemented in accordance with the foregoing description upon a carrier medium. Suitable carrier media include storage media or memory media such as magnetic or optical media, e.g., disk or CD-ROM, as well as signals such as electrical, electromagnetic, or digital signals, conveyed via a communication medium such as networks 102 and/or 104 of FIG. 1 and/or a wireless link.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

What is claimed is:

1. A computer-implemented method of displaying quotes for a security from two or more sources, the method comprising:
receiving quotes for a security from two or more sources;
displaying one or more quotes from a first source;
determining if one or more quotes from a second source are duplicates of one or more displayed quotes from the first source; and
displaying non-duplicated quotes from the second source.

2. The method of claim 1, further comprising:
detecting an interruption of communications with the first source;
determining if one or more quotes from the second source are duplicates of one or more quotes from the first source after detecting an interruption of communications from the first source; and
displaying non-duplicated quotes from the second source after detecting an interruption of communications from the first source.

3. The method of claim 2, wherein a connection server detects the interruption of communications with the first source.

4. The method of claim 2, further comprising:
detecting if communications with the first source have resumed;
determining if one or more quotes from the second source are duplicates of one or more quotes from the first source after detecting that communications with the first source have resumed; and
displaying non-duplicated quotes from the second source after detecting that communications with the first source have resumed.

5. The method of claim 4, wherein a connection server detects if communications with the first source are no longer interrupted.

6. The method of claim 1, wherein one of the sources is an market center.

7. The method of claim 1, wherein one of the sources is a securities market.

8. The method of claim 1, wherein one of the sources comprises the NASDAQ Stock Market.

9. The method of claim 1, wherein the first source is an ECN and the second source is the NASDAQ Stock Market.

10. The method of claim 1, wherein the first source is the NASDAQ Stock Market and the second source is an ECN.

11. The method of claim 1, wherein the quotes comprise bid prices for securities.

12. The method of claim 1, wherein the quotes comprise ask prices for securities.

13. A computer system configured to implement the method of claim 1.

14. A computer-implemented method of displaying quotes for a security from two or more sources, the method comprising:
receiving quotes for a security from two or more sources,
receiving user preference data that identifies sources to be suppressed;
displaying one or more quotes from a first source, wherein the first source was not identified to be suppressed; and
suppressing display of one or more quotes from a second source, wherein the second source was identified to be suppressed, and wherein the one or more quotes from the second source which are suppressed, are duplicates of one or more quotes from the first source which are displayed.

15. The method of claim 14, further comprising:
detecting an interruption of communications with the first source; and
displaying one or more quotes from the second source, wherein the one or more quotes from the second source displayed corresponded to quotes that would be suppressed if communications with the first source were not interrupted.

16. The method of claim 15 wherein a connection server detects the interruption of communications with the first source.

17. The method of claim 15, further comprising:
detecting if communications with the first source are no longer interrupted;
displaying one or more quotes from the first source; and
suppressing display of one or more quotes from the second source, wherein the one or more quotes from the second source which are suppressed, are duplicates of one or more quotes from the first source which are displayed.

18. The method of claim 17 wherein a connection server detects if communications with the first source are no longer interrupted.

19. The method of claim 14 wherein one of the sources is a market center.

20. The method of claim 14 wherein one of the sources comprises a securities market.

21. The method of claim 14 wherein one of the sources comprises the NASDAQ Stock Market.

22. The method of claim 14 wherein duplicate quotes are provided by an ECN and the NASDAQ Stock Market.

23. The method of claim 14 wherein the first source is an ECN and the second source is the NASDAQ Stock Market.

24. The method of claim 14 wherein the first source is the NASDAQ Stock Market and the second source is an ECN.

25. The method of claim 14 wherein the quotes comprise bid prices for securities.

26. The method of claim 14 wherein the quotes comprise ask prices for securities.

27. A computer system configured to implement the method of claim 14

28. A carrier medium which stores program instructions, wherein the program instructions are computer-executable to implement a method of displaying quotes for a security from two or more sources, the method comprising:
receiving quotes for a security from two or more sources;
displaying one or more quotes from a first source;
determining if one or more quotes from a second source are duplicates of one or more displayed quotes from the first source; and
displaying non-duplicated quotes from the second source.

29. The carrier medium of claim 28, wherein the method further comprises:
detecting an interruption of communications with the first source;
determining if one or more quotes from the second source are duplicates of one or more quotes from the first source; and
displaying non-duplicated quotes from the second source.

30. The carrier medium of claim 29, wherein the method further comprises:
detecting if communications with the first source have resumed;
determining if one or more quotes from the second source are duplicates of one or more quotes from the first source; and
displaying non-duplicated quotes from the second source.

31. A carrier medium which stores program instructions, wherein the program instructions are computer-executable to implement a method of displaying quotes for a security from two or more sources, the method comprising:
receiving quotes for a security from two or more sources,
receiving user preference data that identifies sources to be suppressed;
displaying one or more quotes from a first source, wherein the first source was not identified to be suppressed; and
suppressing display of one or more quotes from a second source, wherein the second source was identified to be suppressed, and wherein the one or more quotes from the second source which are suppressed, are duplicates of one or more quotes from the first source which are displayed.

32. The carrier medium of claim 31, wherein the method further comprises:
detecting an interruption of communications with the first source; and
displaying one or more quotes from the second source, wherein the one or more quotes from the second source displayed corresponded to quotes that would be suppressed if communications with the first source were not interrupted.

33. The carrier medium of claim 32, wherein the method further comprises:
detecting if communications with the first source are no longer interrupted;
displaying one or more quotes from the first source; and
suppressing display of one or more quotes from the second source, wherein the one or more quotes from the second source which are suppressed, are duplicates of one or more quotes from the first source which are displayed
